(19) United States
(12) Patent Application Publication
(10) Pub. No.: US 2011/0094522 A1
(43) Pub. Date: Apr. 28, 2011

(54) DENTAL APPLIANCE AND METHODS OF USING THE SAME

(76) Inventor: Wendy Weisflog, Scottsdale, AZ (US)

(21) Appl. No.: 12/607,925

(22) Filed: Oct. 28, 2009

(51) Int. Cl. A61C 5/14

(52) U.S. Cl. 128/861

(57) ABSTRACT

Described herein is a dental appliance including a right piece adapted for simultaneously covering a plurality of back teeth of a right side of a lower jaw and a plurality of back teeth of a right side of an upper jaw of a mouth, and a left piece independent of the right piece and adapted for simultaneously covering a plurality of back teeth of a left side of a lower jaw and a plurality of back teeth of a left side of an upper jaw, and methods of using the same.

### FIELD OF THE INVENTION

This invention is directed to a dental appliance and methods of using the same, and more particularly to a dental appliance having a right piece adapted for insertion into a right side of the mouth, and a left piece independent of the right piece for insertion into a left side of the mouth.

### BACKGROUND OF THE INVENTION

Many people grind and/or clench their teeth, for example, under stress. This may lead to temporomandibular joint (“TMJ”) pain and/or other head and/or facial pain. This often occurs at night, when the individual is sleeping. Dental appliances, such as mouthguards, are used to reduce TMJ pain.

### SUMMARY OF THE PREFERRED EMBODIMENTS

In accordance with one aspect of the present invention, there is provided a dental appliance. The dental appliance includes a right piece adapted for simultaneously covering a plurality of back teeth of a right side of a lower jaw and a plurality of back teeth of a right side of an upper jaw of a mouth; and a left piece independent of the right piece and adapted for simultaneously covering a plurality of back teeth of a left side of the lower jaw and a plurality of back teeth of a left side of the upper jaw of the mouth.

In accordance with another aspect of the present invention, there is provided a method for preventing a mouth from fully closing. The method includes the steps of providing a dental appliance having a right piece adapted for simultaneously covering a plurality of back teeth of a right side of a lower jaw and a plurality of back teeth of a right side of an upper jaw of a mouth; and a left piece independent of the right piece and adapted for simultaneously covering a plurality of back teeth of a left side of the lower jaw and a plurality of back teeth of a left side of the upper jaw of the mouth. The method further includes the steps of inserting the appliance into the mouth and establishing contact between the upper and lower portions on a corresponding side of the mouth; thereby preventing the mouth from fully closing.

In accordance with yet another aspect of the present invention there is provided a dental appliance. The dental appliance includes a right piece adapted for simultaneously covering a plurality of back teeth of a right side of a lower jaw and a plurality of back teeth of a right side of an upper jaw; and a left piece independent of the right piece and adapted for simultaneously covering a plurality of back teeth of a left side of the lower jaw and a plurality of back teeth of a left side of the upper jaw. Preferably, each of the right and left pieces has a tooth-facing surface, the tooth-facing surface comprised at least partially of a gel-material.

### BRIEF DESCRIPTION OF THE DRAWINGS

The invention may be more readily understood by referring to the accompanying drawings in which:

FIG. 1 is a perspective view of a dental appliance in a mouth in accordance with one aspect of the present invention;

FIG. 2 is a side elevational view of FIG. 1;

FIG. 3 is a view of an end of the dental appliance of FIG. 1;

FIG. 4 is a cross-section taken along the lines of 4-4 of FIG. 2;

FIG. 5 is a side elevational view of the dental appliance of FIG. 1; and

FIG. 6 is another perspective view of the dental appliance of FIG. 1.

Like numerals refer to like parts throughout the several views of the drawings.

### DETAILED DESCRIPTION OF THE PREFERRED EMBODIMENTS

It will be appreciated that terms such as “front,” “back,” “top,” “bottom,” “left,” “right,” “above,” and “side” used herein are merely for ease of description and refer to the orientation of the components as shown in the figures. It should be understood that any orientation of the components described herein is within the scope of the present invention.

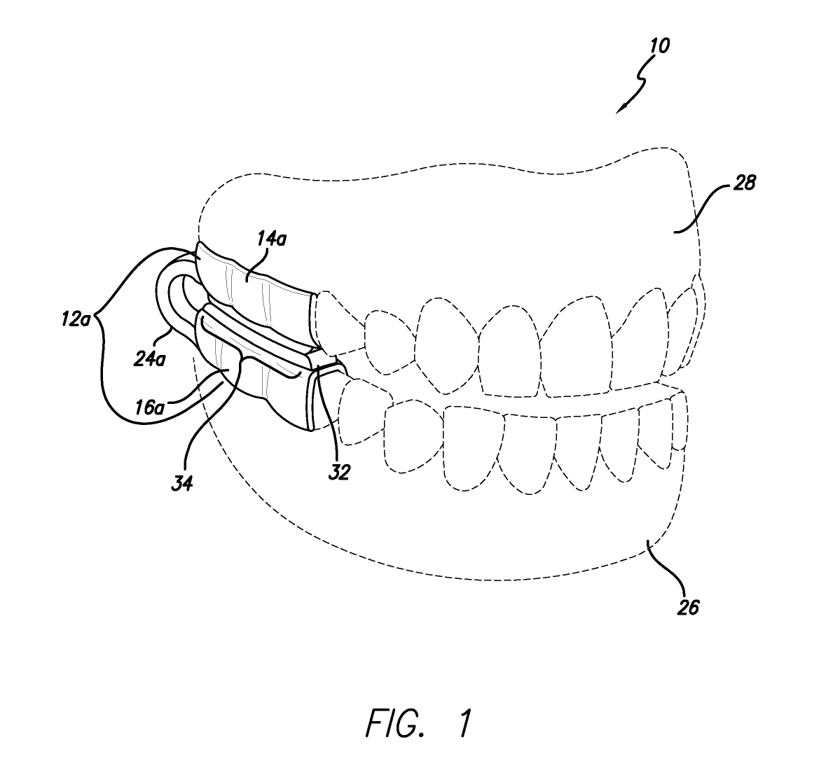

As shown in FIGS. 1-6, a preferred embodiment of a dental appliance 10 (as used herein, “dental appliance” may be interchangeable with “mouthguard” or “nightguard”) is shown and described. Preferably, the dental appliance 10 includes a pair of pieces 12a and 12b that are independent of one another. The piece that is adapted for insertion into a right side of the mouth is referred to herein as 12a, and the piece that is adapted for insertion into the left side is referred to herein as 12b. Moreover, each of the components that are associated with the right piece 12a include an “a” suffix, and each of the components that are associated with the left piece 12b include the “b” suffix. For example, right and left pieces may be referred to individually as 12a and/or 12b or they may be referred to generically as piece 12.

As used herein, “independent” means that the right piece 12a is not connected to the left piece 12b when the dental appliance 10 is used (as used herein “used” is interchangeable with “placed,” “inserted” “worn,” or the like) in the mouth. As such, the right piece 12a may be removed while the left piece 12b remains in the mouth, or vice versa. In other embodiments, the right piece 12a and the left piece 12b may not be independent. In this regard, the right piece 12a and the left piece 12b may be connected to each other in any other suitable manner before, during, and/or after insertion into the mouth. In yet other embodiments, the dental appliance 10 may not include right piece 12a or may not include left piece 12b. In this regard, the dental appliance 10 will only have one piece 12 adapted for insertion into one side of the mouth. As such, the individual may use only one piece.

In a preferred embodiment, and as best seen in FIGS. 1, 5, and 6, the right piece 12a includes upper portion 14a and lower portion 16a, and the left piece 12b includes upper portion 14b and lower portion 16b. Preferably, the upper portion 14 and lower portion 16 are connected together by a connecting portion 24. In other embodiments, the connecting portion 24 may be replaced or supplemented by any other suitable means of attaching the upper 14 and lower 16 portions together and/or the upper and lower portions may be formed from one piece.

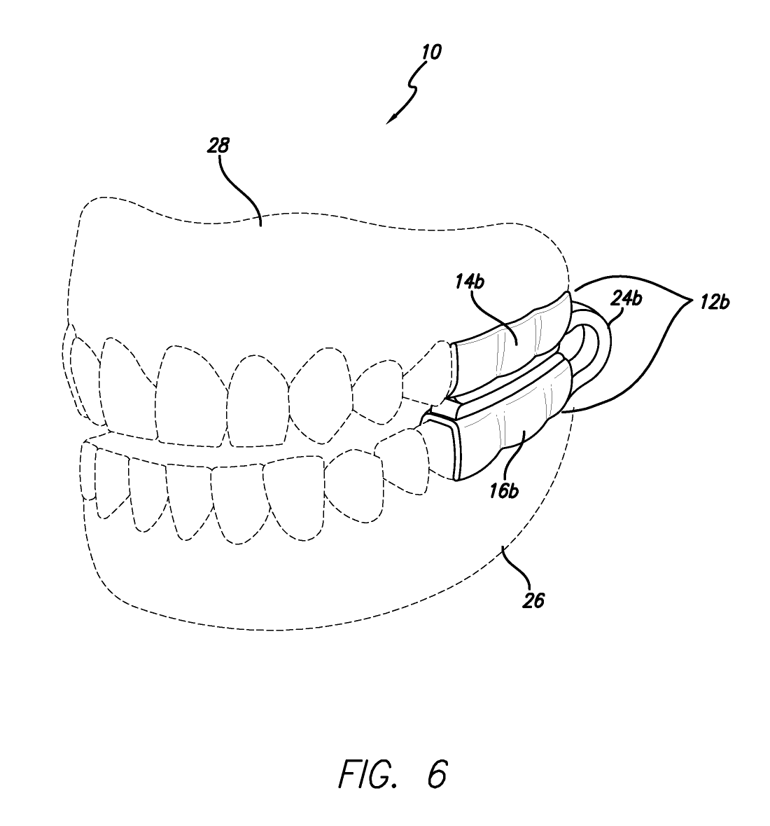

In a preferred embodiment, and as seen in FIGS. 1, 5, and 6 the right piece 12a is adapted for simultaneously covering a plurality (as used herein, “plurality” means “at least one”) of back teeth of a right side of a lower jaw 26 and a plurality of back teeth of a right side of an upper jaw 28 of a mouth; and left piece 12b (as seen in FIG. 6) is adapted for simultaneously covering a plurality of back teeth of a left side of a lower jaw 26 and a plurality of back teeth of a left side of an upper jaw 28 of the mouth. In a more preferred embodiment, the right piece 12a is adapted for simultaneously covering all of the molars of the right side of the lower jaw 26 and all of the molars of the right side of the upper jaw 28 of the mouth; and left piece 12b is adapted for simultaneously covering all of the molars of the left side of the lower jaw 26 and all of the molars of the left side of the upper jaw 28 of the mouth. In a highly preferred embodiment, and referring to FIG. 1, the right piece 12a is adapted for simultaneously covering three molars of the right side of the lower jaw 26 and three molars of right side of the upper jaw 28 in the mouth; and (as seen in FIG. 6) the left piece 12b is adapted for simultaneously covering three molars of the left side of the lower jaw 26 and three molars of the left side of the upper jaw 28. As used herein, “back teeth” refers to “posterior teeth,” or the molars, premolars, and/or the bicuspids. As used herein, “three molars” refers to either the first, second, and third molars or to the first and second molars and the second bicuspid (if, for example, the third molar or wisdom tooth is removed). As used herein, “cover” may refer to “securely cover” such that the piece does not fall off as the individual is sleeping, moving his or her mouth or tongue, etc. Preferably, the dental appliance 10 should be sufficiently snug/secure such that it stays in place unless removed by the individual.

In a preferred embodiment, the dental appliance 10 does not cover and/or make contact with any front teeth. As used herein, “front teeth” refers to “anterior teeth,” or canines and incisors. In other embodiments, the dental appliance 10 may cover and/or contact the front teeth.

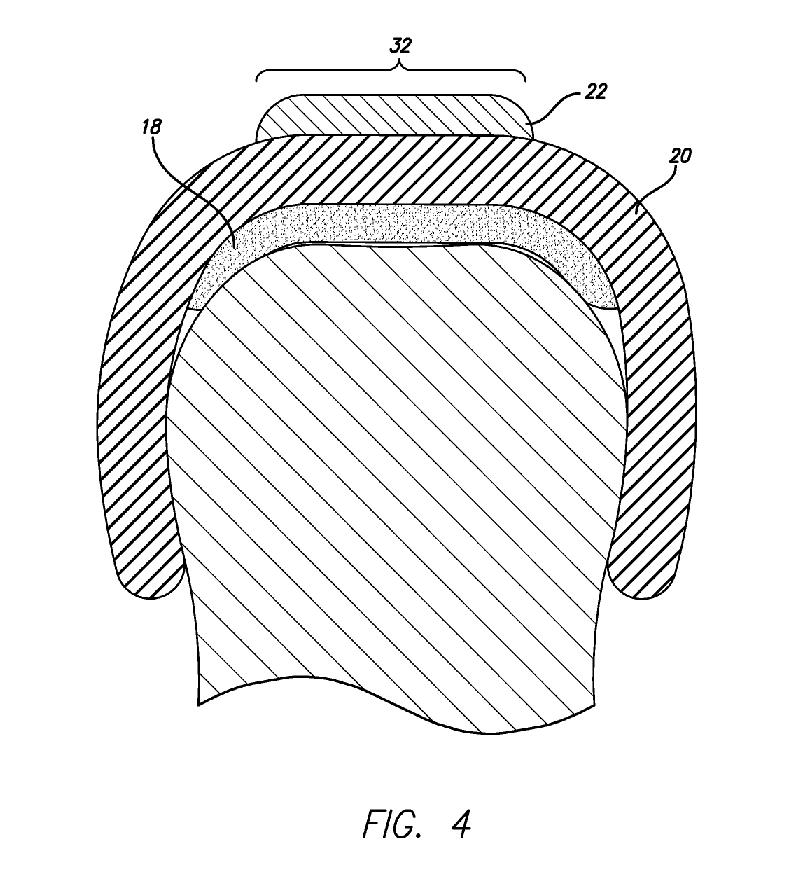

In a preferred embodiment, and as seen in FIGS. 3 and 4, the upper portion 14 and lower portion 16 each includes a first layer 18, a middle layer 20 at least partially disposed on the first layer 18, and a top layer 22 at least partially disposed on the middle layer 20 (reference to “18,” “20,” and “22” generically refers to the first layer, middle layer, and top layer, respectively, on any piece or portion unless otherwise specified). Preferably, the upper 14 portion has the same or substantially same layer composition as the lower portion 16. Preferably, the middle layer 20 has a larger surface area than the surface area of the first layer 18 or the surface area of top layer 22. In other embodiments, the middle layer 20 may have the same surface area as the other layers, or may have a smaller surface area. In yet other embodiments, the dental appliance 10 may include less than three layers or more than three layers and/or may include layers different from those described above. In yet other embodiments, the upper portion 14 may not have the same or substantially same layer composition as the lower portion 16.

In a preferred embodiment, first layer 18 is at least partially comprised of a gel material. In a highly preferred embodiment, the first layer 18 is at least partially comprised of a silicone material. Preferably, the first layer 18 is about 0.01 mm to about 2 mm thick. In a more preferred embodiment, the first layer 18 is about 0.10 mm to about 1 mm thick. In a highly preferred embodiment, the first layer 18 is about 0.30 mm to about 0.60 mm thick. Preferably, and referring to FIG. 3, the first layer 18 protects and cushions the teeth. In other embodiments, the first layer 18 may be less than about 0.01 mm thick or more than about 2 mm thick. In yet other embodiments, the first layer 18 may be comprised of any other suitable material, such as a material that forms a cushion between the plurality of teeth covered and the remainder of the appliance. In yet other embodiments, the first layer 18 may not be included.

In a preferred embodiment, the top layer 22 is at least partially comprised of a soft, durable material, such as a plastic. Suitable plastics include, but are not limited to, thermoplastics, polyethylene, polystyrene, polyvinyl chloride, polytetrafluoroethylene, acrylics, polyesters, silicones, polyurethanes, and/or halogenated plastics or the like. Preferably, and as seen in FIG. 1, top layer 22 has a width 32 and a length 34, and the width 32 and the length 34 of the top layer 22 on the lower portion 16 is the same or substantially the same as a width and a length of the top layer 22 on the upper portion 14 on a corresponding (or “same”) side of the mouth, As seen in FIG. 3, the top layer 22 of the upper portion 14 makes contact with the top layer 22 of lower portion 16 when the mouth is closed or substantially closed. Having similar dimensions allows the top layers to make contact and keep the mouth slightly open. Preferably, the middle layer 20 of the upper portion 14 does not make contact with the middle layer 20 of the lower portion 16, or vice versa. In other embodiments, the top layer 22 of the upper portion 14 may not have the same or substantially the same length and width as the length and width of the top layer 22 of the lower portion 16. In yet other embodiments, the top layer 22 may be comprised of any other suitable material or may not be included.

In a preferred embodiment, the top layer 22 is of sufficient thickness such that contact between the top layer 22 of the upper portion 14 and the top layer 22 of the lower portion 16 on the corresponding side of the mouth prevents the mouth from fully closing when the mouth is closed or substantially closed. In this regard, top layer 22 is flat or substantially flat. Preferably, the top layer 22 is about 0.01 mm to about 2 mm thick; more preferably about 0.1 mm to about 1 mm thick, and highly preferably about 0.3 mm to about 0.6 mm thick. In yet other embodiments, the top layer 22 may be more than about 2 mm or less than about 0.01 mm thick. In yet other embodiments, the top layer 22 may not be flat or substantially flat.

In a preferred embodiment, the middle layer 20 is at least partially comprised of a soft, durable material such as a plastic. Suitable examples of plastics are described above. In a highly preferred embodiment, the middle layer 20 is more durable/more soft than the top layer 22. Preferably, the middle layer 20 is about 0.01 mm to about 2 mm thick; more preferably about 0.10 mm to about 1 mm thick, and highly preferably about 0.30 mm to about 0.60 mm thick. In yet other embodiments, the middle layer 20 may be more than about 2 mm or less than about 0.01 mm thick. In yet other embodiments, the middle layer 20 may not be included. In yet other embodiments, the middle layer 20 may not be more durable/more soft than top layer 22 and/or may be harder than top layer 22.

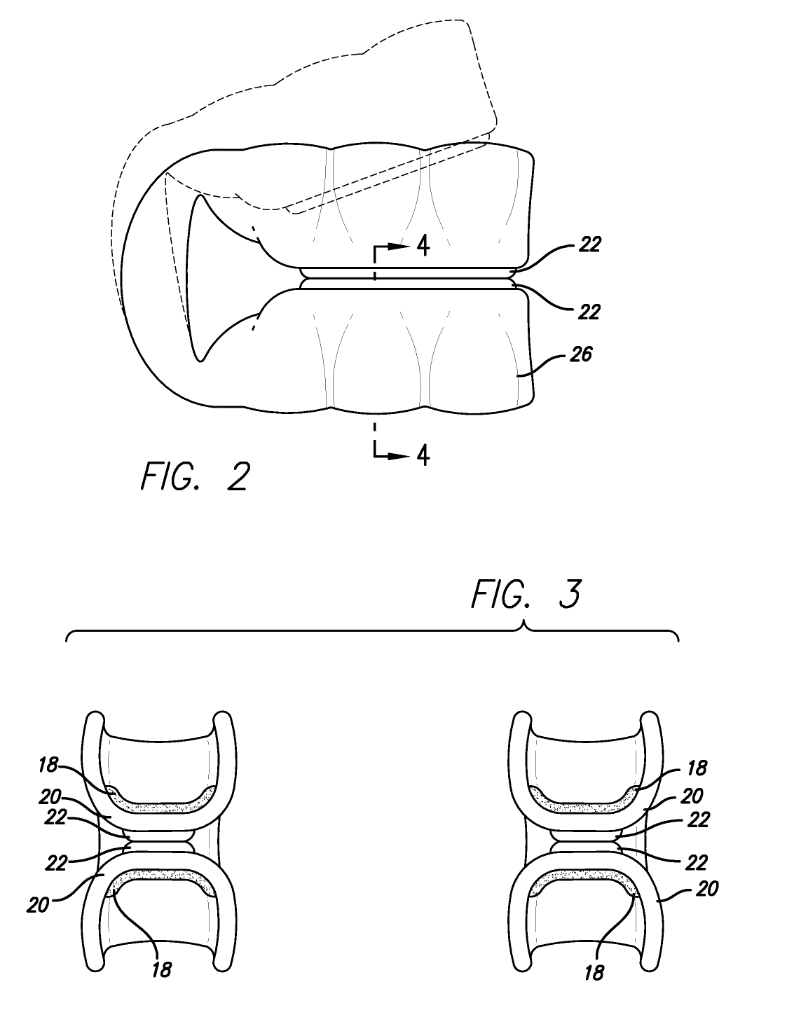

In a preferred embodiment, the methods of the present invention are as follows. Preferably, a dental appliance of the present invention is provided, namely an appliance having right and left pieces, each adapted for simultaneously covering a plurality of back teeth on a right and a left side of the mouth, respectively. Each piece is inserted/placed into its respective side of the mouth simultaneously, or one-by-one. Once the pieces are inserted/placed in the appropriate side of the mouth, the mouth may be closed/substantially closed to establish contact between the upper and lower portions on the corresponding side of the mouth. For example, the movement of the mouth from an open position to a closed or substantially closed position is best seen in FIG. 2. In this position, the top layers make contact, as seen in FIGS. 1-3, 5, and 6.

In a preferred embodiment, the appliance is worn at night. In other embodiments, the dental appliance may be worn during the day and/or night. The appliance may be worn for any length of time.

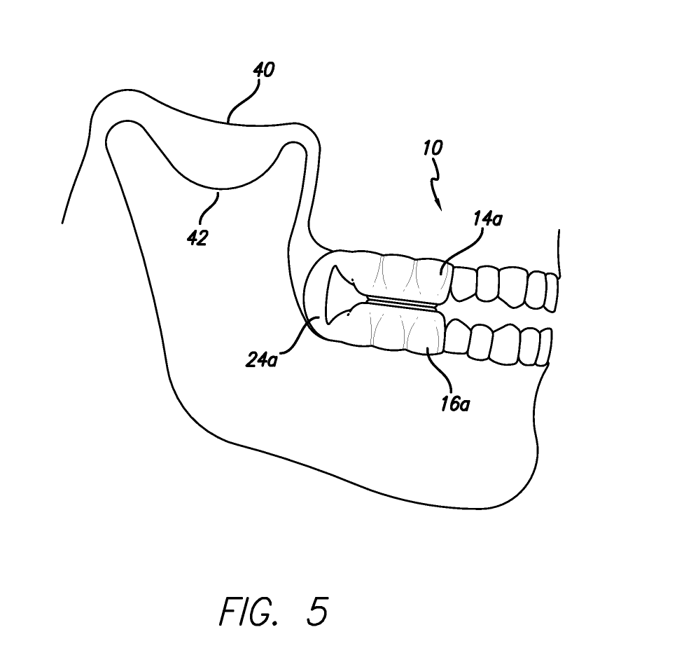

In a preferred embodiment, the methods of the present invention include preventing an individual's mouth from fully closing, reducing/eliminating pain and/or clenching of the front teeth. In this regard, and as best seen in FIG. and 5, contact of the top layers preferably keeps the mouth in a slightly open position. As such, the front teeth do not touch, and the mouth is prevented from closing. Keeping the mouth in a slightly open position prevents the front teeth from clenching. Preferably, and as best seen in FIG. 5, the methods of the present invention include preventing the temporal bone 40 of the upper jaw and the mandible bone 42 of the lower jaw from engaging or reducing the amount of engagement. As such, inflammation in the temporomandibular joint is reduced and/or eliminated. In other embodiments, the methods of the present invention include preventing the maxilla and the mandible from engaging or reducing the amount of engagement, and/or the methods of the invention include reducing/eliminating any kind of tension and/or inflammation in the muscles/bones surrounding the temporomandibular joint or the joint itself.

In a preferred embodiment, the dental appliance 10 is preformed (i.e., not made from impressions). In yet other embodiments, the dental appliance 10 may be made from impressions and/or custom-made in any other suitable manner.

While certain embodiments of the invention have been described, these embodiments have been presented by way of example only, and are not intended to limit the scope of the inventions. Indeed, the novel methods and elements described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A dental appliance comprising:
a. a right piece adapted for simultaneously covering a plurality of back teeth of a right side of a lower jaw and a plurality of back teeth of a right side of an upper jaw of a mouth; and
b. a left piece independent of the right piece and adapted for simultaneously covering a plurality of back teeth of a left side of a lower jaw and a plurality of back teeth of a left side of an upper jaw of the mouth.

2. The dental appliance of claim 1, wherein the right piece is independent of the left piece when the appliance is inserted into the mouth.

3. The dental appliance of claim 1, wherein the dental appliance does not cover any front teeth of the upper or lower jaw.

4. The dental appliance of claim 1, wherein each of the right and left pieces includes:
a. an upper portion adapted to snugly cover at least a plurality of back teeth of the upper jaw;
b. a lower portion adapted to snugly cover a plurality of back teeth of the lower jaw; and
c. a connector portion for attaching the upper and lower portions together.

5. The dental appliance of claim 1, wherein each of the right and left pieces is adapted to simultaneously snugly cover all molars of the upper jaw and all molars of the lower jaw.

6. The dental appliance of claim 1, wherein each of the upper and lower portions includes:
a. a first layer adapted to make contact with the teeth and comprised of a gel material;
b. a middle layer at least partially disposed on the first layer; and
c. a top layer at least partially disposed on the middle layer and comprised of a plastic material.

7. The dental appliance of claim 6, wherein the top layer is flat or substantially flat.

8. The dental appliance of claim 6, wherein the gel material is at least partially comprised of silicone.

9. The dental appliance of claim 7, wherein each top layer has a width and a length, wherein a width and a length of a top layer of the upper portion is the same or substantially the same as a width and a length of a top layer of the lower portion on a corresponding side of the mouth.

10. The dental appliance of claim 9, wherein the top layer of the upper portion and the top layer of the lower portion on the corresponding side of the mouth are adapted to make contact with each other when the dental appliance is inserted into the mouth and the mouth is closed or substantially closed.

11. The dental appliance of claim 10, wherein each top layer is of a sufficient thickness such that contact between the top layer of the upper portion and the top layer of the lower portion on the corresponding side of the mouth prevents the front teeth of the upper and lower jaws from engaging each other when the mouth is closed or substantially closed.

12. A dental appliance comprising:
a. a right piece adapted for simultaneously covering a plurality of back teeth of a right side of a lower jaw and a plurality of back teeth of a right side of an upper jaw; and
b. a left piece independent of the right piece and adapted for simultaneously covering a plurality of back teeth of a left side of a lower jaw and a plurality of back teeth of a left side of an upper jaw;
wherein each of the right and left pieces includes a tooth-facing surface; wherein the tooth-facing surface includes a layer of gel material at least partially disposed on the surface.

13. A method of preventing the mouth from fully closing, the method comprising:
a. providing the dental appliance of claim 3;
b. inserting the appliance into the mouth;
c. establishing contact between the upper and lower portions on a corresponding side of the mouth;
thereby preventing the mouth from fully closing.

14. The method of claim 10, wherein preventing the mouth from fully closing prevents the mandible and the maxilla from engaging.

15. The method of claim 13, wherein the step of establishing contact includes the step of establishing contact between a top layer of the upper portion and a top layer of the lower portion on a corresponding side of the mouth.

16. A dental appliance comprising:
a. a right piece adapted for simultaneously covering a plurality of back teeth of a right side of a lower jaw and a plurality of back teeth of a right side of an upper jaw;
b. a left piece independent of the right piece and adapted for simultaneously covering a plurality of back teeth of a left side of a lower jaw and a plurality of back teeth of a left side of an upper jaw; wherein
each of the right and left pieces has a tooth-facing surface, the tooth-facing surface comprised at least partially of a gel material.

17. The dental appliance of claim 1, wherein the appliance is preformed.

18. The method of claim 13, wherein the step of inserting includes the steps of
a. inserting the right piece into a right side of the mouth and allowing the upper portion to snugly cover the plurality of back teeth of the right side of the upper jaw and allowing the lower portion to snugly cover the plurality of back teeth of the right side of the lower jaw; and
b. inserting the left piece into a left side of the mouth and allowing the upper portion to snugly cover the plurality of back teeth of the left side of the upper jaw and allowing the lower portion to snugly cover the plurality of back teeth of the left side of the lower jaw.
